(19) United States
(12) Patent Application Publication
(10) Pub. No.: US 2006/0139693 A1
(43) Pub. Date: Jun. 29, 2006

(54) Printing system, computer readable medium recording a driver program, and printing device

(75) Inventor: Tetsuya Suzuki, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/293,089

(22) Filed: Dec. 5, 2005

(30) Foreign Application Priority Data
Dec. 9, 2004 (JP) 2004-356606

(51) Int. Cl. G06K 15/00

(52) U.S. Cl. 358/1.18; 358/1.12

(57) ABSTRACT

A printing system and similar which, with respect to so-called form printing, can reduce the amount of memory required and improve the efficiency of processing is provided. The printing system comprises: a host device, which divides image data of a form into square blocks the length of one side of which is equal to the height of a band, and which generates form data comprising the image data of each square block in which exists an image of the form, position information for each square block, and rotation information for the form, and which transmits the form data; and a printing device which registers the transmitted form data, and, upon receiving a form printing request, performs processing to merge the form data with the printing data based on the rotation information and position information for the form data, and which executes print processing for the requested form printing.

### CROSS-REFERENCE TO RELATED APPLICATIONS

This application is based upon and claims the benefit of priority from the prior Japanese Patent Application No. 2004-356606, filed on Dec. 9, 2004, the entire contents of which are incorporated herein by reference.

### BACKGROUND OF THE INVENTION

1. Field of the Invention

This invention relates to a printing system and similar comprising a host device which issues printing requests and a printing device which executes printing according to such requests, and in particular relates to a printing system and similar which, with respect to so-called form printing, can reduce the required memory capacity and improve the efficiency of processing.

2. Description of the Related Art

Among printing devices of the prior art are devices having so-called form printing functions to insert common lines, characters and similar on each page when performing printing (see for example the device described in Japanese Patent Laid-open No. 11-327849). In such form printing, the lines, characters and similar inserted in common, and other form data, and the printing data for each page are generated and saved, and merge processing in which the form data and printing data are superposed is performed to execute print processing.

There are a number of methods of form printing in the prior art; in one method, the above merge processing is performed on the side of the host device issuing the printing request to the printing device. In this method, the generated form data is held by the host device, and at the time of execution of form printing the required form data is retrieved, superposed with the printing data, and the resulting data is transmitted to the printing device to issue a print request.

In another method, generated form data is saved on the side of the printing device, and merge processing with printing data is performed by the printing device. In this case, normally when the host device requests form printing, the printing data and information indicating the form data to be used are transmitted, and the printing device retrieves the corresponding form data from the stored location and executes the form printing.

However, in the above-described form printing method in which merge processing is performed on the side of the host device, sufficient space must be secured in storage means to store all the form data on the personal computer or similar which is the host device. There are other undesirable aspects as well, such as the use of a large amount of memory space during merge processing, which adversely affects other processing.

In the above-described form printing method in which merge processing is performed on the side of the printing device, normally form data is saved and managed in page units, and in merge processing of each page, superpositioning is performed in which, one page's worth of printing data overwrites one page's worth of form data. Hence when performing form printing regardless of the contents of the form data, it is necessary to perform overwriting of one page's worth for each page. Moreover, in printing devices capable of double-sided printing and which adopt a method in which the printing direction is different on opposite sides, when performing double-sided form printing it is necessary to prepare two sets of form data for the same form with different directions, and storage space for this purpose is necessary.

### SUMMARY OF THE INVENTION

Hence an object of this invention is to provide a printing system comprising a host device which issues printing requests and a printing device which executes printing according to such printing requests, which, with respect to so-called form printing, can reduce the memory capacity required and improve processing efficiency.

In order to achieve the above object, one aspect of the invention is a printing system capable of form printing, comprising: a host device, which receives form image data to be used in the form printing, divides the image data into square blocks the length of one side of which is equal to the height of a band used as a unit of processing during printing processing, generates form data for the form comprising image data for each of the square blocks in which the image of the form exists, position information in the form for each square block, and rotation information for the form based on the processing direction when performing printing using the form, and transmits the form data; and a printing device, which receives and registers the form data transmitted from the host device, and upon receiving a form printing request using the form data performs merge processing of the form data and the printing data of an image to be printed together with the form based on the rotation information of the form data and the position information for each square block, and executes printing processing of the requested form printing. Hence, by means of this invention data for a portion in which a form image exists among the form image for one page is transmitted and stored, and is used in merge processing with printing data, so that the data storage area to be secured for form printing can be reduced, and processing can be made more efficient. Moreover, the form data is divided into square data one side of which is equal to the band height, so that appropriate merge processing of the form data and printing data can be performed in the direction appropriate to the printing direction in the printing device.

Further, a preferred embodiment of the above invention is characterized in that the form data generated by the host device comprises a value of α semitransparent merge processing ratio, and in merge processing of the form data with the printing data in the printing device, semitransparent merge processing is performed based on the value of the semitransparent merge processing ratio.

Further, a preferred embodiment of the above invention is characterized in that the value of the semitransparent merge processing ratio can be set through user operation of the printing system.

In order to achieve the above object, one aspect of the invention is computer readable medium recording a driver program, which causes a host device to execute processing to issue form printing requests to a printing device, and which causes the host device to execute the steps of receiving image data of a form to be used in the form printing, dividing the image data into square blocks the length of one side of which is equal to the height of a band used as a unit of processing during printing processing, generating form data for the form comprising image data for each of the square blocks in which an image of the form exists, position information in the form for each square block, and rotation information for the form based on the processing direction when performing printing using the form, transmitting the form data to the printing device, and registering the form data in the printing device; and, upon a request for form printing using the form data, transmitting to the printing device the printing data of the image to be printed together with the form and information to identify the form data, and issuing a request for the form printing.

Further, a preferred embodiment of the above invention is characterized in that the form data generated comprises a value of α semitransparent merge processing ratio, and in printing processing using the form data in the printing device, semitransparent merge processing is performed based on the value of the semitransparent merge processing ratio.

In order to achieve the above object, one aspect of the invention is a printing device capable of form printing, which, stores form data for the form comprising image data for each of square blocks in which an image of the form exists upon dividing image data of a form to be used in the form printing into square blocks the length of one side of which is equal to the height of a band used as a unit of processing during printing processing, position information in the form for each square block, and rotation information for the form based on the processing direction when performing printing using the form; upon receiving a form printing request using the form data, performs merge processing of the form data and the printing data of an image to be printed together with the form based on the rotation information of the form data and the position information for each square block; and executes printing processing of the requested form printing.

Further objects and characteristics of the invention will become clear from the embodiments of the invention explained below.

### BRIEF DESCRIPTION OF THE DRAWINGS

FIG. 1 shows the configuration of an embodiment of a printing system employing this invention;

FIG. 2 is a flowchart illustrating processing at the time of generation and registration of form data;

FIGS. 3A-3F are drawings used to explain processing to generate form data;

FIGS. 4A and 4B are drawings used to explain the configuration and header information of form data;

FIGS. 5A-5C are drawings used to explain rotation directions;

FIG. 6 is a flowchart illustrating the details of processing during form printing;

FIGS. 7A-7C illustrate the details of form printing to be executed;

FIGS. 8A and 8C schematically indicate the state in which form data and printing data are stored;

FIGS. 9A-9F are drawings used to explain processing to merge printing data and form data; and,

FIGS. 10A and 10B illustrate output results.

### DESCRIPTION OF THE PREFERRED EMBODIMENTS

Below, embodiments of the invention are explained referring to the drawings. However, these embodiments do not limit the technical scope of the invention. In the drawings, the same reference numbers or reference symbols are assigned to components which are the same and similar.

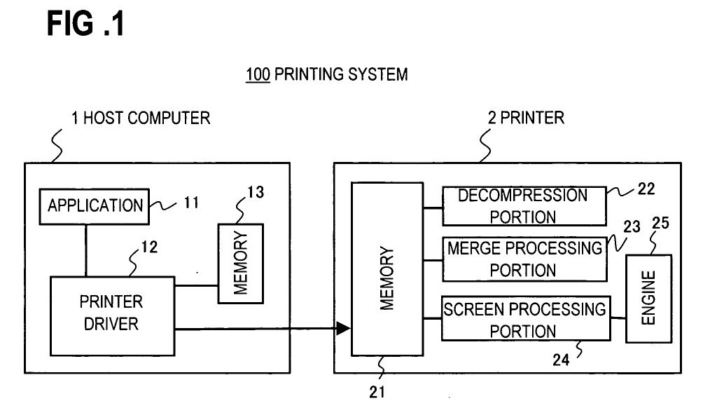

FIG. 1 shows the configuration of an embodiment of a printing system employing the invention. The printing system 100 shown in FIG. 1 is a printing system employing the invention and comprising a host computer 1 and printer 2. The printing system 100 subdivides the form data used in form printing into squares one side of which is of length equal to the height of a band; together with the position information and rotation information of them, only the portion in which there is an image is managed, and when printing processing is performed, form data for the required squares is superposed through semitransparent merge processing onto the printing data with an appropriate position and direction. By this means, efficient form printing can be realized.

The host computer 1 comprised by the printing system 100 is the host device in this embodiment, and issues printing requests to the printer 2; the host computer 1 performs expansion processing to expand image data into drawing data for individual pixels, color conversion processing from RGB to CMYK, and compression processing, after which the data is transmitted to the printer 2. Hence this printing system 100 is a so-called host-based system. With respect to form printing, the host computer 1 generates form data and requests registration of the generated form data in the printer 2, and, at the time of form printing, transmits printing data and information identifying the form data for merging to the printer 2, and requests form printing.

As shown in FIG. 1, the host computer 1 comprises an application 11, printer driver 12, and memory 13. The host computer 1 can comprise a so-called personal computer or similar.

The application 11 is for example document creation software or some other source of printing requests, and passes the data for printing to the printer driver 12 in a prescribed format.

The printer driver 12 is a portion which receives the printing request from the application 11, generates the image data to send to the printer 2, and transmits the image data to the printer 2. In the printer driver 12, during the process of generating image data to transmit to the printer 2, the above-described expansion processing, color conversion processing, compression processing and similar are performed; but the printer driver 12 has a characteristic relating to form printing, and in particular has a characteristic relating to form data generation, registration processing, and processing upon a form printing request, the details of which are described below. The printer driver 12 can be configured comprising a program to specify the procedure for processing, and a control device or similar which executes processing according to the program.

The above-described program is installed on the host computer 1 from CD and the like which stores the program, or downloaded to the host computer 1 via the Internet from the prescribed site.

The memory 13 is storage means comprised by the host computer 1, used for various purposes, and temporarily stores data in each of the stages until the image data for transmission to the printer 2 is generated. Also, identification information for the different form data (for example, form numbers) generated and registered in the printer 2 is stored in this memory.

The printer 2 is a printing device comprised by the printing system 100 which receives image data from the host computer 1 and executes printing based on the image data. For example, the printer 2 may be a four-cycle laser printer. In this printer 2, with respect to form printing, form data generated by the host computer 1 is registered and managed, and when there is a form printing request, the corresponding form data is retrieved and processing to merge the form data with the printing data is executed.

As indicated in FIG. 1, the printer 2 comprises memory 21, a decompression portion 22, a merge processing portion 23, a screen processing portion 24, an engine 25, and similar.

The memory 21 is storage means comprised by the printer 2, and stores image data transferred in succession from the printer driver 12, data generated in different processing stages, registered form data, and similar.

The decompression portion 22 is a portion which, at the start of printing processing, retrieves compressed data from memory 21 and performs processing to restore the data to its original state.

The merge processing portion 23 is a portion which performs processing to merge printing data and form data when performing form printing; specific processing details are described below.

The screen processing portion 24 is a portion which performs screen processing of decompressed data, and converts data for each pixel into dot image data. The engine 25 is a portion which executes printing to print media based on the data resulting from screen processing.

The decompression portion 22, merge processing portion 23, and screen processing portion 24 may comprise an ASIC, or may comprise a program and CPU.

The printing system 100 of this embodiment, having the configuration described above, has characteristics relating to form printing as described above; below, processing at the time of form data generation and registration, and processing at the time of form printing execution are described in detail.

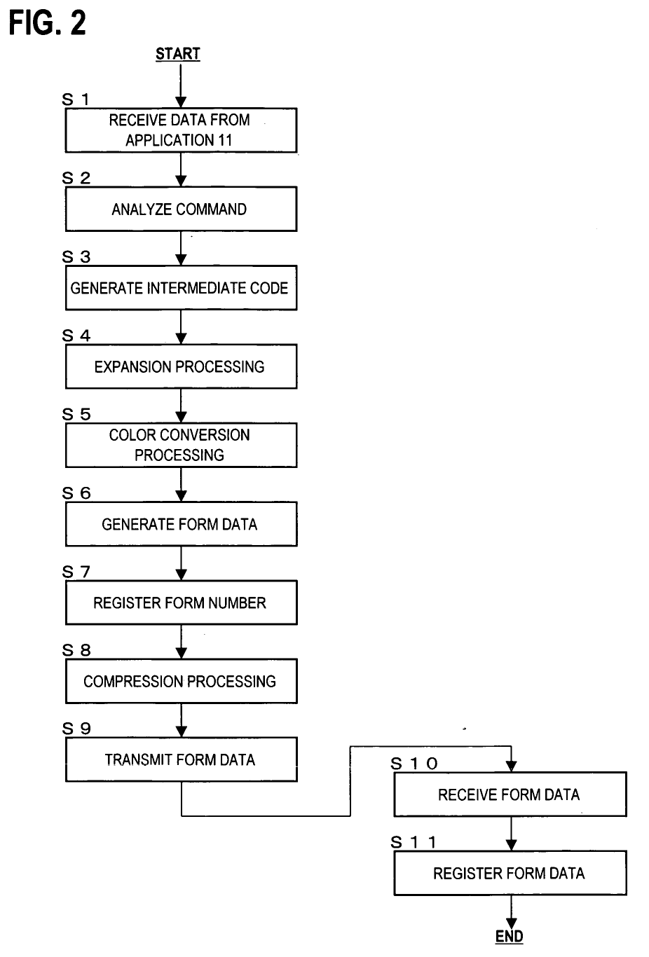

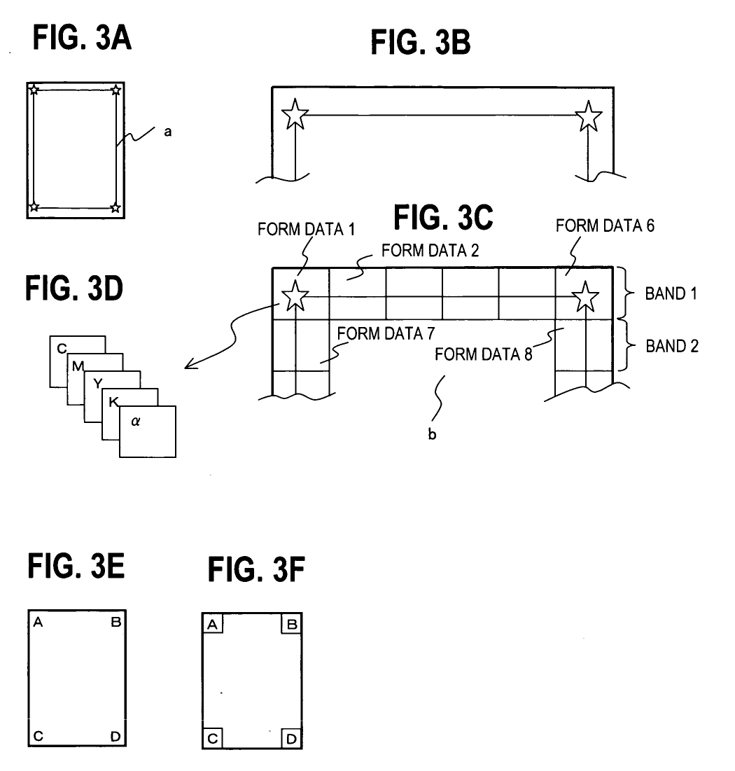

FIG. 2 is a flowchart illustrating the procedure of processing at the time of form data generation and registration. When newly generating and registering form data, first the user employs a prescribed application 11 comprised by the host computer to generate an image of the form. That is, the lines, symbols, and similar to be used in common on each page during printing are created by drawing or some other method. FIG. 3 is used to explain processing to generate form data. A form created by the user may for example be, as in FIG. 3A, a line border with stars in the four corners (“a” in the figure), or may, as in FIG. 3E, be the letters “A”, “B”, “C”, “D” in the four corners.

When registering the image of such a form as form data, the user issues a request to this effect using an interface provided by the application 11. As a result of this request, the application 11 transmits the image data for the form and information indicating that the data is a form to the printer driver 12 in a prescribed format.

The printer driver 12, upon receiving the data from the application 11 (step S1), analyzes the command portion comprised by the data (step S2), and recognizes that the received image data is for use as form data.

Next, the printer driver 12 generates intermediate codes from the received form image data (step S3). Here, the image data received from the application 11 consists of drawing object units, but in the intermediate codes, these are data divided into bands. A band is the result of dividing the range of one printed page into areas of prescribed height; in processing subsequent to expansion processing in the printer driver 12, bands are the units of processing in print processing within the printer 2.

Thereafter, the printer driver 12 expands the intermediate codes generated and stored in memory 13 to generate drawing data which is the data for individual pixels, and stores the result in memory 13. That is, expansion processing is performed (step S4). Here, the image of the form generated by the user is assumed to be a color image. Hence the generated drawing data is configured having density values in each of the RGB colors and attribute information for each pixel. The drawing data generated is the data for a form, and so the attribute information includes a coefficient α of semitransparent merging, used in processing to merge the form data with printing data.

Next, the generated drawing data is subjected to color conversion processing (step S5). Here, each of the RGB density values of each pixel, as described above, is converted to density values in the CMYK colors used by the printer 2.

In the case of an ordinary printing request, after color conversion, processing is performed to compress the generated drawing data and transmit the data to the printer 2; but in processing to generate and register the form, processing is performed to generate form data from the generated drawing data (step S6). This processing is a major characteristic of this printing system 100.

In this processing, the drawing data after color conversion for the form created by the user is divided into square blocks one side of which is the height of the above-described bands, and form data is generated for the form created by the user comprising image data for each square block in which image data exists as well as the value of the semitransparent merging coefficient α. Header information for the form data as a whole, as well as header information for each square block, are also added to the generated form data. Also, identification information for the form is set in the generated form data. For example, a form number is appended as the identification information.

Processing to generate this form data is explained in detail referring to FIG. 3. Suppose that the form a illustrated in FIG. 3A is created, and that drawing data after color conversion is generated for the form. FIG. 3B shows in enlargement only the top portion of the drawing data. Here, the drawing data is shown as the image represented when drawing based on the drawing data.

The printer driver 12 performs processing to divide the drawing data into square blocks, one side of which is equal to the height of the above-described bands. FIG. 3C shows the manner of this division. As indicated in FIG. 3C, a single page is divided into “band 1”, “band 2”, . . . , and the data in each band is divided in succession to have the same height and the same width, so that for example “band 1” is in this example divided into six square blocks. Then, the blocks are names form data 1, form data 2, . . . , in succession beginning from the first block on the left. As a result, “band 1” comprises the six square blocks which are form data 1 through 6.

With respect to “band 2”, images exist only in the square blocks on both ends, and so the square block data for this band is only the two items form data 7 and form data 8. That is, because there is no image in the portion indicated by “b” in FIG. 3C, the data in this portion is not included in the form data. In other words, of the drawing data after color conversion, this portion (the portion indicated by “b”) is deleted.

Similarly for band 3 and subsequent bands, division processing is performed, and square data (form data 1 through n) is created for portions of the entire form (one page) in which there exist images.

As indicated in FIG. 3D, each of the square data items comprises CMYK density values and a semitransparent merging coefficient α value, in the sequence of planes, for each pixel comprised by the square range.

In the case of a form in which “A”, “B”, “C”, “D” appear in the four corners, as illustrated in FIG. 3E, after division into square blocks as in FIG. 3F, because the only square blocks in which there are images are the four corner blocks, in this case the form data for the form consists of the four square data items.

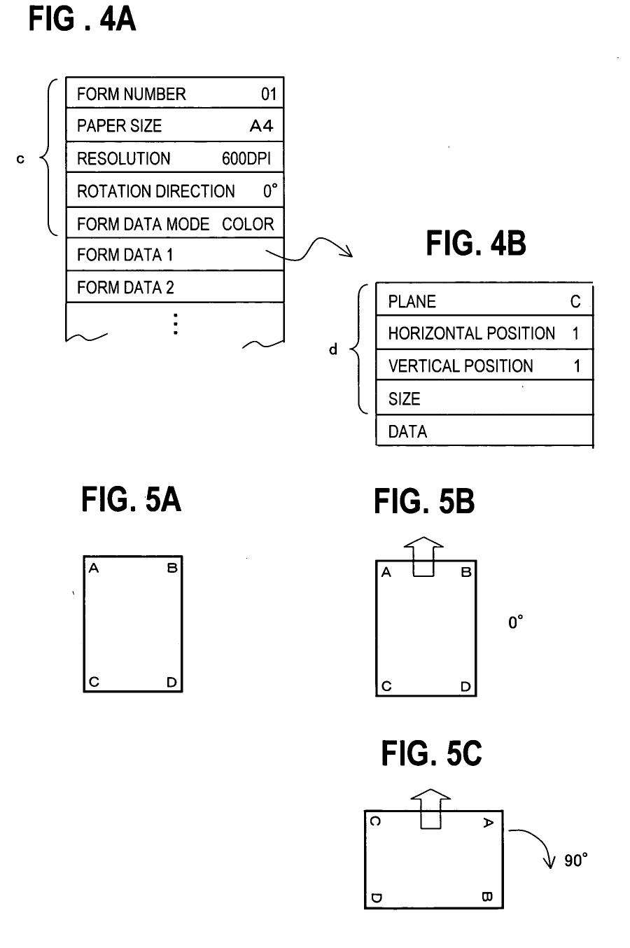

In this way, when form data is generated from drawing data, the above-described header information is added. FIG. 4 is a figure used to explain the form data configuration and header information. FIG. 4A shows the overall configuration of form data and header information for the form data as a whole. The portion indicated by “c” in FIG. 4A is the header information; following this are the above-described square data items (form data 1 to n).

At the beginning of the header information is the “form number”, which is, for example, “01” or similar information, as indicated on the right-hand side. This form number is the above-described identification information for each form data item. In the example shown in FIG. 3, for example, the form number for the form shown in FIG. 3E is “01”, and the form number for the form shown in FIG. 3A is “02”.

The “paper size” and “resolution” are respectively the size of the paper onto which the form printing of the form data is to be performed, and the printing resolution. For example, as indicated on the right side, this may be “A4” and “600 DPI”.

Next, “rotation direction” indicates the angle through which rotation should be performed for printing, taking into account the printing direction in the printer 2. FIG. 5 is used to explain this rotation direction. For a form with “A”, “B”, “C”, “D” in the four corners as shown in FIG. 5A, when form data is generated in the direction shown in the figure, that is, the direction such that data is processed in the order band 1, band 2, . . . , in order from the top of the figure, and when the printer 2 performs print processing in the direction shown in FIG. 5B, that is, in the same direction as in FIG. 5A, then the “rotation direction” is “0°”; whereas when the printer 2 performs print processing in the direction shown in FIG. 5C, the “rotation direction” becomes “90°”. When for example the form shown in FIG. 5A is size A4, and when the printer 2 is a device which prints only onto A4 size paper, then as indicated in FIG. 5B the “rotation direction” is “0°”, whereas when the printer 2 can be used with both A4 size and with A3 size paper, the “rotation direction” is “90°” as shown in FIG. 5C.

The “form data mode” indicates whether the form data is color data or monochrome data, or similar, and is for example the information “color” appearing on the right-hand side.

As shown in FIG. 3D, the form data 1 through n stores color information and α value information in the sequence of planes for each square block. FIG. 4B illustrates the data configuration and header information in the C plane of form data 1. The portion indicated by “d” in FIG. 4B is the header information; following this the actual data, in this case the C density values for each pixel comprised by the square, are stored.

The “plane” indicates data among the CMYKα data stored in the above-described plane order; for example, on the right, information for the “C” plane is shown.

Next, “horizontal position” and “vertical position” are position information for the square data, indicating the position of the form data as a whole. For example, in form data 1 shown in FIG. 3C, the “horizontal position” and “vertical position” are “1” and “1”, as indicated on the right side of FIG. 4B. In the form data 2 shown in FIG. 3C, these are “2” and “1”; in the form data 7 shown in FIG. 3C, these are “1” and “2”.

“Size” stores information related to the data size for the plane and similar.

In this way, header information is generated for other planes also, and is added to “data”.

As explained above, drawing data is divided and square data is generated for portions having images, and the position information for the square data and rotation information for the form data in terms of the above-described rotation direction are added to generate form data; then, returning to FIG. 2, the form number (identification information) for this generated form data is registered (step S7). Here, the printer driver 12 registers the above-described form number “01” or similar in memory 13, but the form data itself is stored and managed on the side of the printer 2, and is not stored in memory 13.

Next, the printer driver 12 performs prescribed compression processing of the generated form data (step S8), and after reducing the data size, transmits the form data to the printer 2 (step S9).

The printer 2 receives the form data (step S10), stores the form data in a prescribed area in memory 21 which is the storage means, and registers the form data to enable use during form printing (step S11).

In this way, processing is executed to generate and register form data in the printing system 100, and the registered form data is used at the time of form printing.

In the above, a case in which the form data is color data was explained; but when the form data is monochrome data, substantially similar processing is performed to generate and register the form data. However, the color conversion processing (S5) of FIG. 2 is not performed, and each of the square data items (form data 1 to n) comprises only two planes, K and α.

Further, when the user wants to delete form data registered, the printer driver 12 erases the form number of the form data from memory 13 and transmits a delete request to the printer 2, based on operations at the host computer 1 instructing deletion of form data. Upon receiving the request, the printer 2 deletes the specified form data from memory 21, placing the printer 2 into a state in which the form data cannot be used. In this deletion processing, the form number is used to identify the form data in question.

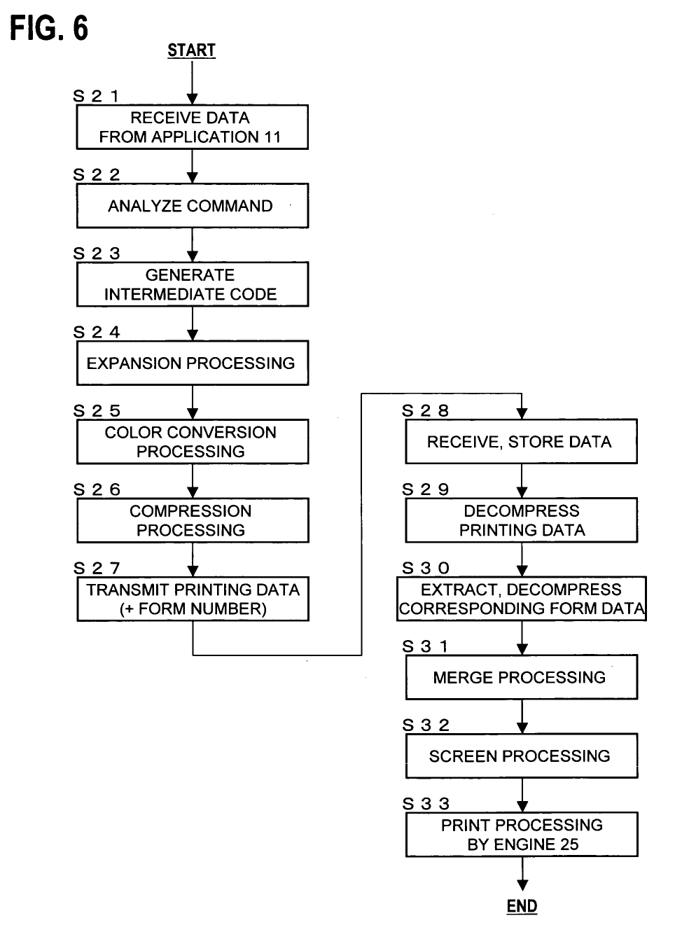

Next, the details of processing in the printing system 100 during form printing are explained. FIG. 6 is a flowchart illustrating the details of processing during form printing. When performing form printing, first the user creates the text, graphics or similar for printing in the application 11 of the host computer 1. Then, an instruction is issued to perform form printing of the text or graphics for printing. At this time, the form data to be used as the form is selected by specifying the above-described form number or similar.

When this printing instruction is issued, image data for printing (printing data) and a command comprising the form number of the form data to be used are issued from the application 11, and the printer driver 12, upon receiving this data (step S21), first analyzes the command therein (step S22). Then, the printer driver 12 performs, in order, intermediate code generation (step S23), expansion processing into drawing data (step S24), color conversion from RGB into CMYK in the case of color data (step S25), and compression processing (step S26), according to the analyzed command, similarly to the case of a normal printing request.

Thereafter, the necessary command is added to the compressed printing data, and this data is transmitted to the printer 2 (step S27). The command for transmission comprises information indicating that the printing is form printing, and the form number of the form data selected by the user.

The printer 2, upon receiving the data, stores the printing data in a prescribed area of the memory 21, and analyzes the command (step S28). Then, preparations necessary for the print processing are performed in the engine 25 or similar, according to the details of the command.

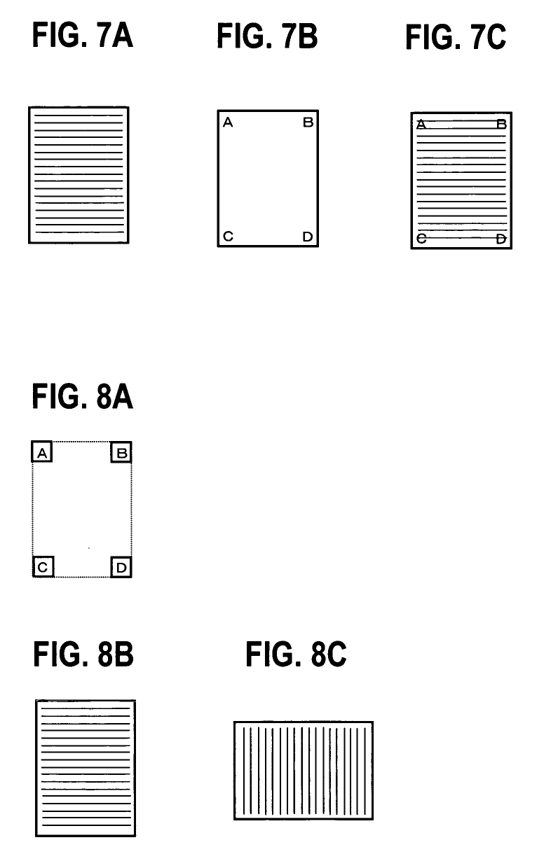

FIG. 7 illustrates the details of form printing to be executed. FIG. 7A shows the text for printing; each of the plurality of horizontal lines represents a line of text. FIG. 7B shows the form to be used in form printing, that is, the form selected by the user. And FIG. 7C illustrates the output image after form printing. The size of the paper for printing is assumed to be A4.

When analyzing the command, the printer 2 may ascertain information, for example, such as that shown in FIG. 7. Upon entering a state in which processing of form printing can be begun, the following processing is performed in succession, in band units.

First, processing is performed to decompress the printing data which had been received and stored (step S29). As explained above, the printing data has been transmitted from the host computer 1 in a compressed state, and so decompression processing is performed by the decompression portion 22 to restore the data to its original state, and after decompressing the printing data is stored in a prescribed area of memory 21.

FIG. 8 shows schematically the stored state of form data and printing data. FIG. 8 illustrates the case of performing the form printing shown in FIG. 7; FIG. 8A shows the state in which the form data to be used has been registered. This form data is for a form with “A”, “B”, “C”, “D” in the four corners, and in actuality comprises four square data items for the four corners and the above-described types of header information. Hence the four square data items each have position information indicating the positions shown in FIG. 8A, and are not saved in memory 21 as shown in the figure.

FIG. 8B shows the state of one page's worth of printing data for one color (plane) stored in memory 21, in a case in which the printer 2 is a device which performs print processing in the same direction as the received printing data and is, for example, a dedicated A4 printer. In this case, the rotation direction for the form data shown in FIG. 8A is 0°.

FIG. 8C shows the state of one page's worth of printing data for one color (plane) stored in memory 21, in a case in which the printer 2 is a device which performs print processing in a direction different by 90° from the received printing data and is, for example, an A4/A3 size printer. In this case, the rotation direction for the form data shown in FIG. 8A is 90°.

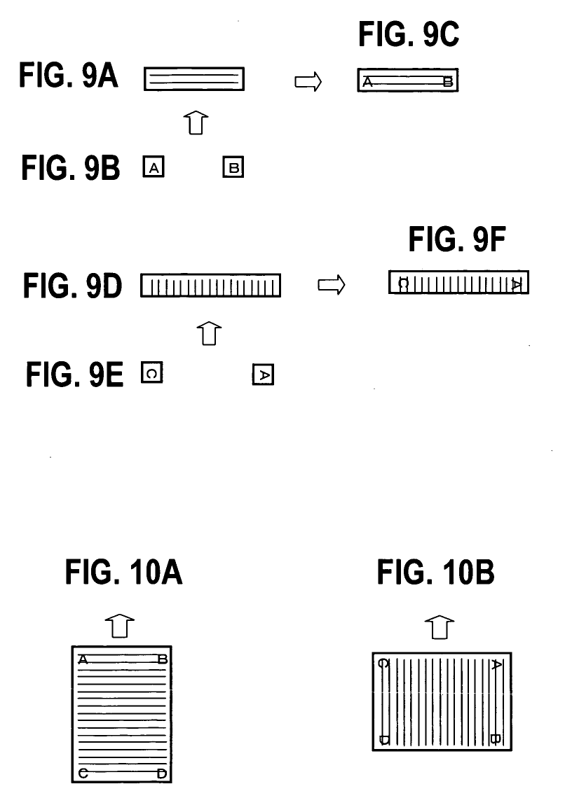

FIG. 9 is used to explain processing to merge the printing data and the form data. FIG. 9A shows the state of printing data in memory 21 after performing the above-described decompression processing for the first band of printing data, when the printer 2 has stored printing data such as that of FIG. 8B. FIG. 9D shows the state of printing data in memory 21 after the above-described decompression processing of the first band of printing data, when the printer 2 has stored printing data such as that of FIG. 8C.

Next, the printer 2 extracts each of the square data items at positions corresponding to the decompressed printing data for the form data with the received form number, and decompresses the data extracted (step S30). Specifically, based on rotation direction information for the form data, the square data to be superposed in the range of the decompressed printing data is determined, and each of the square data items are retrieved from memory 21. The retrieved square data items are each decompressed by the decompression portion 22, and are then rotated in the direction for correct superpositioning on the printing data, and are written to a prescribed area of memory 21.

In the form printing example shown in FIG. 8, for the printing data in FIG. 9A described above, the form data is decompressed and written to memory 21 as shown in FIG. 9B. In this case, the form data rotation direction is 0°, and so the data for the band at the top in FIG. 8A is equivalent to the range of the decompressed printing data (FIG. 9A), and the square data items on the left and right containing the characters “A” and “B” are extracted and decompressed and are written without modification to memory 21.

On the other hand, for the printing data shown in FIG. 9D described above, the form data is decompressed and written to memory 21 as shown in FIG. 9E. In this case, the rotation direction of the form data is 90°, so that the two square data items containing the characters “A” and “C” in the range of the topmost band in the state after rotating clockwise through 90° the form data shown in FIG. 8A as a whole, are extracted and decompressed. The square data items are then rotated to the direction coinciding with the printing data and written to memory 21.

Next, processing to merge the decompressed printing data and form data is performed by the merge processing portion 23 (step S31). In merge processing, decompressed printing data and form data are retrieved for portions in which the decompressed form data exists, semitransparent merge processing is executed using the value α with the form data, and the resulting density values are written back to prescribed portions of the area in which is stored the decompressed printing data.

In the example shown in FIGS. 9A and 9B, only the portions of two square data items shown in FIG. 9B are read by the merge processing portion 23 among the data in FIGS. 9A and 9B, semitransparent merge processing is performed, and the result is written back to the original positions in FIG. 9A. The result of this merge processing is shown in FIG. 9C.

In the example shown in FIGS. 9D and 9E, only the portions of two square data items shown in FIG. 9E are read by the merge processing portion 23 among the data of in FIGS. 9D and 9E, semitransparent merge processing is performed, and the result is written back to the original positions in FIG. 9D. The result of this merge processing is shown in FIG. 9F.

In this way, when merge processing is performed, the resulting drawing data is sent to the screen processing portion 24 and screen processing is performed (step S32), the resulting data is sent to the engine 25, and print processing is performed by the engine 25 based on this data (step S33).

When the processing from step S29 on is performed for all bands and all colors of one page for printing, the print processing for that page ends, and the result of the desired form printing is output. FIG. 10 illustrates the output results. In FIG. 10A, print processing is performed in the direction of the arrow, and the output result for the case of the example shown in FIG. 9A through FIG. 9C is obtained. Similarly, in FIG. 10B print processing is performed in the direction of the arrow, and the output result for the case of the example shown in FIG. 9D through FIG. 9F is obtained. In each case, the result obtained is according to the output image after form printing shown in FIG. 7C.

Processing is performed during form printing execution as described above; however, a configuration may be adopted in which the user can, at the time of form data registration or at the time of form printing execution, select the value of the semitransparent merge processing ratio α of the above-described form data. In this selection operation, the value of α may be set to a desired value for the entire form, or different values of a may be set depending on the portion within the form for one page.

As explained above, in the printing system 100 of this embodiment, form data is generated on the side of the host computer 1 at the time of form data generation and registration and is sent to the printer 2, and the form data is stored and managed on the side of the printer 2. This form data is divided into square blocks of size such that one side is equal to the height of a band, which is the processing unit in the printing system 100, and does not have data in portions in which no image exists, but has position information in the form and rotation information for processing by the printer 2 for each square block of the form.

At the time of form printing, the printing data and identification information for the form data are transmitted from the host computer 1, and at the printer 2 form data for superpositioning is extracted based on the identification information, rotation information for the form data, and position information for each square block, semitransparent merge processing with the printing data is executed for appropriate positions and directions, and form printing is completed.

Hence there is no need to store the form data itself on the side of the host computer 1, and so space is not used in the data storage means, and merge processing at the time of form printing is performed on the side of the printer 2, so that processing by the host computer 1 can be performed in a short length of time.

Further, only form data are generated for the portions for which there are images, so that the time for transmission to the printer 2 at the time of form data registration can be shortened, and the area for data storage in the printer 2 can be kept small. Also, during form printing the form data itself is not sent to the printer 2, so that the time for transmission of data to the printer 2 during form printing can be shortened.

In merge processing at the time of form printing, each of the above-described square data items has position information and form data rotation direction information, so that even if the printer 2 does not have data for the entire form, appropriate superposition processing is possible. In particular, when the processing direction differs at the time of form data generation and at the time of printing (for example, when the rotation direction is 90° or similar), because the form data is divided into squares with the above-described size, each of the square data items can be rotated in 90° units and used, and so appropriate processing can be performed.

As described above, the merge processing is executed only for portions in which a form image exists, so that processing can be performed rapidly.

Even in the case of a device for which, in double-sided printing, the printing direction is different for the top side and the bottom side, when performing form printing the above-described square data items can be rotated, so that a single form data item can be used on both sides, and there is no need to prepare and save form data with different directions for each side.

As explained above, superpositioning of printing data and form data is performed in semitransparent merge processing, so there is no need to decompress and save the printing data and form data and write the printing data onto the form data as in the prior art, and it is sufficient to save the decompressed printing data and the portions of the form data for which there are images, so that the data storage area used in merge processing can be reduced.

In this embodiment, the host device which generated the form data and the host device which issued requests for form printing using the form data were the same; however, when the printer 2 is connected to a plurality of host devices via a network or similar, the host device which generates the form data and the host device which issues form printing requests may be different. In such cases, the processing at the time of form data generation and registration, and the processing at the time of form printing, are performed similarly.

The protected scope of this invention is not limited to the above embodiment, but extends to the inventions described in the scope of claims and to inventions equivalent thereto.

What is claimed is:

1. A printing system capable of form printing, comprising:
a host device, which receives form image data to be used in the form printing, divides the image data into square blocks, the length of one side of which is equal to the height of a band used as a unit of processing during printing processing, generates form data for the form comprising image data for each of the square blocks where the image of the form exists, position information in the form for each square block, and rotation information for the form based on the processing direction when performing printing using the form, and transmits the form data; and
a printing device, which receives and registers the form data transmitted from the host device, and upon receiving a form printing request using the form data, performs merge processing of the form data and the printing data of an image to be printed together with the form based on the rotation information of the form data and the position information for each of the square blocks, and executes printing processing of the requested form printing.

2. The printing system according to claim 1, wherein
form data generated by the host device comprises a semitransparent merge processing ratio value, and
in processing to merge the form data and the printing data in the printing device, semitransparent merge processing is performed based on the semitransparent merge processing ratio value.

3. The printing system according to claim 2, wherein the value of the semitransparent merge processing ratio can be set through an operation by a user of the printing system.

4. A computer readable medium recording a driver program causing a host computer to execute processing to issue a form printing request to a printing device, the driver program causing the host device to execute the steps of:
receiving image data of a form to be used in the form printing, dividing the image data into square blocks the length of one side of which is equal to the height of a band used as a unit of processing during printing processing, generating form data for the form comprising image data for each of the square blocks in which an image of the form exists, position information in the form for each square block, and rotation information for the form based on the processing direction when performing printing using the form, transmitting the form data to the printing device, and registering the form data in the printing device; and
transmitting, upon a request for form printing using the form data, to the printing device the printing data of the image to be printed together with the form and information to identify the form data, and issuing a request for the form printing.

5. The computer readable medium according to claim 4, wherein the generated form data comprises a semitransparent merge processing ratio value, and
upon printing processing in the printing device using the form data, semitransparent merge processing is performed based on the semitransparent merge processing ratio value.

6. A printing device capable of form printing, in which, form data is stored for the form comprising image data for each of square blocks in which an image of the form exists upon dividing image data of a form to be used in the form printing into square blocks the length of one side of which is equal to the height of a band used as a unit of processing during printing processing, position information in the form for each square block, and rotation information for the form based on the processing direction when performing printing using the form; and
upon receiving a form printing request using the form data, merge processing is performed of the form data and the printing data of an image to be printed together with the form based on the rotation information of the form data and the position information for each square block, and printing processing of the requested form printing is executed.
